(19) United States
(12) Patent Application Publication
(10) Pub. No.: US 2006/0068205 A1
(43) Pub. Date: Mar. 30, 2006

(54) Composite material used for manufacturing heat exchanger fins with high thermal conductivity

(75) Inventor: Alexandre Potier, Gennevilliers (FR)

Correspondence Address: DENNISON, SCHULTZ, DOUGHERTY & MACDONALD, 1727 KING STREET, SUITE 105, ALEXANDRIA, VA, 22314, US

(73) Assignee: Carbone Lorraine Composants

(21) Appl. No.: 11/233,366

(22) Filed: Sep. 23, 2005

Related U.S. Application Data
(60) Provisional application No. 60/623,234, filed on Nov. 1, 2004.

(30) Foreign Application Priority Data
Sep. 24, 2004 (FR) 04 10131

(51) Int. Cl. B32B 9/00; B32B 15/04; B21D 53/04; B23P 15/26

(52) U.S. Cl. 428/408; 428/457; 29/890.039; 29/890.054

(57) ABSTRACT

Multi-layer material based on expanded graphite reinforced by a metal comprising at least one inner layer (10) of recompressed expanded graphite and two outer metal layers (20), the said recompressed expanded graphite having a density greater than 1.6 g/cm³. The thickness of each outer metal layer (20) is less than one tenth of the total thickness of the multi-layer structure. The outer metal layers (20) are advantageously provided with uniformly distributed pins (21) oriented towards the recompressed expanded graphite inner layer (10), the density of the said pins (21) being greater than 25 per dm² and their height being greater than 15% of the final thickness of the recompressed expanded graphite inner layer (10). The said pins may be the result of punching of the outer metal layer (20), the wall around the perforated orifice being deformed and in the form of a substantially axisymmetric projection.

### FIELD OF THE INVENTION

The invention relates to the manufacture of heat exchangers used to dissipate heat originating from a heat source. More particularly, it relates to manufacturing of plane elements efficiently dissipating heat by conduction in the plane of the elements, for example cooling fins on heat sinks for electronic components.

### BACKGROUND OF THE INVENTION

One of the main problems that arises for the development of electronic components is increased heat losses due to the continuous increase in operating frequencies and/or the increase in power in the case of power generators. These losses may cause high temperature increases of components, which can cause degradation or even destruction of the said components. To overcome these phenomena, it has become essential to add heat dissipation devices (heat sinks) to components, designed to absorb heat emitted by the component and then dissipate it into the environment, usually ambient air, through a large heat exchange surface area.

For practical and economic reasons, many of these heat sinks are of the type consisting of a heat exchanger with fins, usually made from good heat conducting metals such as aluminium or copper. These heat sinks dissipate heat emitted by components into the surrounding air. They comprise a base or a support with one face designed to come into contact with a heat source, for example an electronic component, and fins fixed to the said base and arranged such that they have a large exchange surface area with the surrounding medium. Their performances depend firstly on the exchange surface area between the ambient air and the fins, and their ability to transfer the largest possible heat flux between the base and the fin, as far as the end of the fin. Consequently, fins must have good thermal conductivity, at least in the direction of their large dimension, or preferably in all directions in the plane of the fin. A model of the thermal operation of fins shows that for identical geometry, the efficiency of a fin is proportional to the square root of the thermal conductivity of the material from which the fin is made, measured in the plane of the fin. Thus for the same geometry, a copper fin (thermal conductivity of the order of 380 Wm⁻¹K⁻) may be approximately 37% more efficient than an aluminium fin (thermal conductivity of the order of 200 Wm⁻¹K⁻¹). However, aluminium remains the preferred material due to its price which is lower than the price of copper, its lightweight and ease of use (unlike sections made of copper alloys, hot extruded aluminium sections can be obtained in all possible shapes, and particularly sections with concave contours). Copper is used in the most demanding applications in terms of energy quantity to be dissipated.

A large number of other solutions for fin materials have been suggested, tested and even marketed in an attempt to overcome the limitations specific to each of these two materials, all with the same objectives:

high thermal conductivity in the plane of the fins (search for performance);

low density (search for light weight);

low cost.

These attempts and developments include:

the design of an exchanger with fins based on anisotropic graphite, with high thermal conductivity in a plane, presented by Martin R. Vogel in 1994 at the 10th “IEEE SEMI-THERM” conference (“Thermal Performance of Air-Cooled Hybrid Heat Sinks for a Low Velocity Environment”, SEMI-THERM X., Proceedings of 1994 IEEE/CPMT 10th, pp. 17-22)

patent application US 2004 0000391, which describes the principles adopted for producing and using high density recompressed expanded graphite sheets (d>1.7 g/cm³) (for the purposes of this presentation, the term “density” is used in its sense normally accepted within the profession, in other words mass per unit volume). These sheets are reinforced by a thermosetting resin matrix and stacked such that the result is a low density multi-layer structure (1.9 g/cm³ max) with thermal conductivity in the plane of the fins comparable to the thermal conductivity of pure copper (400 Wm⁻¹K⁻¹). The thermal properties of recompressed expanded graphite are thus particularly well adapted to plane parts of heat exchangers such as fins. The dense and rigid structure of these fins is composed partly of a thermoplastic material (preferably an epoxy resin set by heat treatment), introduced to form a bond between the layers of recompressed expanded graphite stacked on each other and to provide the assembly with much better mechanical properties than would be obtained using sheets of recompressed expanded graphite without additives. However, this particularly attractive solution has several limitations:
a) the operating temperature must be limited: the most frequently used thermoplastic resins degrade quickly if they are exposed to temperatures of more than 120° C. for a prolonged period. Complex resins have to be used for service at high temperatures, and these resins are still expensive.
b) the temperature reached during manufacturing must also be limited: therefore, it is impossible to use a process that requires high temperatures, for example such as brazing, to fix the fins to their support. This type of process would destroy the material from which the fins are made, by degrading the reinforcing resin.
c) the global thermal conductivity, therefore the cooling performance of the fin, is limited: the volume occupied by the resin occupies a non-zero proportion of the total volume (at least a few percent). The thermal conductivities of thermosetting resins are significantly lower, at least by a factor of 50, than the thermal conductivity of graphite crystals from which the recompressed expanded graphite is composed. Thus, the volume occupied by the resin makes almost no practical contribution to conductivity of the assembly.
d) the fin made with such a multi-layer structure is not very deformable and is fairly fragile: thermosetting resins, introduced in small quantities to avoid degrading thermal performances excessively, are also fragile materials. The combination of a low resin content and the inherent fragility of these resins results in a product that deforms only slightly and is fragile
e) finally, from an economic point of view, manufacturing processes are relatively expensive due to the need for a hot pressing operation carried out to achieve satisfactory densification of the recompressed expanded graphite simultaneously with cross linking of the resin that makes the product rigid. This process requires high power presses that work at low cycles and produce limited numbers of parts per<<batch>>.

The applicant has attempted to produce inexpensive, lightweight, heat exchanger fins that are not very fragile and that can be used within a wide temperature range—compatible with operating conditions of the product to be cooled—that can be fitted onto the support of a heat sink by brazing or by force fitting and finally providing a cooling performance at least as good as would be obtained by the multi-layer structure of recompressed expanded graphite impregnated with resin as described above.

### SUMMARY OF THE INVENTION

A first purpose of the invention is providing a material having a multi-layer structure comprising at least one inner layer of recompressed expanded graphite and two outer metal layers wherein said outer metal layers are relatively thin compared to the total thickness of the multilayer structure. Typically, the thickness of each of said outer metal layer is less than one tenth of the total thickness of the multilayer structure. According to the invention, the heat dissipation is ensured by the recompressed expanded graphite, which is mechanically reinforced by outer metal layers. Said outer metal layers may be made from any metal or metal alloy, or metals that are very good conductors of heat such as copper or aluminium or alloys of them, or metals with very good mechanical characteristics and consequently which can be in the form of very thin skins, the small thickness compensating for their lower thermal conductivity.

The advantage of recompressed expanded graphite is well known. It consists of expanded graphite particles that are mixed and then compressed in the absence of a carbonaceous binder to obtain solid structures with densities typically between about 80 kg/m³ and 2300 kg/m³. There are several means of obtaining expanded graphite particles. For example, they are described in U.S. Pat. No. 3,404,061 (grinding, etching of spaces between hexagonal cross linking planes by an oxidising or halide agent, impregnation of water, heating to more than 100° C.). Finally, these particles are brought together and are then compressed. When compression results in a density of between about 400 kg/m³ and about 1300 kg/m³, the recompressed expanded graphite has attractive elastic properties and is usually called “flexible graphite”. In the context of the invention, the recompressed expanded graphite in the inner layer is compressed to a density greater than the density of conventional flexible graphite.

It has been observed that as the compression applied to expanded graphite particles increases, the structure obtained become dense, some of its physical properties tend to become anisotropic, and particularly electrical and thermal conductivities. When strongly compressed, this type of material loses its insulating properties and its heat conducting properties improve in the plane perpendicular to the compression direction. Thus, a recompressed expanded graphite with a density greater than 1.7 g/cm³ has a coefficient of thermal expansion in the plane perpendicular to the compression close to 400 Wm⁻¹K⁻¹, which is greater than the value for pure copper. Preferably, to obtain good heat conducting properties in its plane, the multi-layer material according to the invention comprises at least one layer of recompressed expanded graphite with a density greater than 1.6 g/cm³, and preferably greater than 1.7 g/cm³.

Typically, for a 1.5 mm thick structure, the outer metal layers are less than 150 μm thick, which is less than one tenth of the total thickness of the structure. Outer steel layers could be significantly thinner, typically 20 μm. Obviously, the outer layers could be composed of the same metal or alloy, or each could be a different metal.

The outer metal layers assure that the structure has good mechanical strength and some deformability. Furthermore, they protect the recompressed expanded graphite layer from abrasion or mechanical shocks. The inner recompressed expanded graphite layer assures that the entire structure has very good thermal conductivity in the plane of the layers; and a low average density.

According to the invention, the multilayer structure comprises an internal structure protected by outer metallic layers. Said internal structure may be said inner layer made of recompressed expanded graphite or may be a multi-layer structure comprising at least one layer made of recompressed expanded graphite, such as the multilayer structure described in US 2004/0000391. When an outer metal layer is adjacent to a layer made of recompressed expanded graphite, the bond between said outer metal layer and said recompressed expanded graphite layer is achieved by an adhesive, or preferably by a mechanical bond, which gives better heat transfer between the layers without introducing a limiting usage temperature to the final structure.

Preferably, when the internal structure is a multilayer structure, it comprises outer layer made of recompressed expanded graphite, so that each external metal layer is adjacent and mechanically bonded to a layer of recompressed expanded graphite.

According to another preferred embodiment of the invention, the metal layers are adjacent to only one layer made of recompressed expanded graphite layer. They are mechanically bonded to said sole layer on both sides of it. Thus, in said preferred embodiments, whatever is the number of the internal structure layers, each outer metal layer is adjacent to a recompressed expanded graphite layer and mechanically bonded to it. The mechanical bond may be assured by using metal layers such as thin sheets provided with uniformly distributed reliefs or pins, facing the graphite layer. In the geometric range in which we are interested, there should be at least 25 of these pins per dm² and their height should be greater than 15% of the final thickness of the recompressed expanded graphite layer.

These pins could for example be made by perforating the metal sheet: each perforation is made on the same side of the said metal sheet such that the wall close to the perforated orifice is deformed and is in the form of a relief projecting above the surface of the said metal sheet, sufficiently high to make the said mechanical bond. The pin may be the result of partial punching of the metal layer, the partially punched part then being folded along the punched part acting as a hinge. The pin may also be made by complete perforation of the sheet, the wall around the perforated orifice being deformed and in the form of an approximately axisymmetric projection.

These characteristics may be quantified by a perforation density (number of perforations/dm²), a perforation size (mm²), a height of the projecting metal pins created by the perforation which is directly proportional to the size of the perforations, or by the percentage of the total surface area occupied by the perforations. In the geometric range in which we are interested, the metal layers must be perforated such that we typically obtain at least 25 perforations per dm², the surface area of these perforations representing at least 3%, and preferably at least 5% of the total surface area of the metal layer, with pins with a height equal to at least 15% of the thickness of the layer of recompressed expanded graphite. Preferably, the surface area of each of these perforations is between 0.2 mm² and 16 mm² .

This type of network of pins not only gives good mechanical bond between the metal layer and the expanded graphite layer, but can also enable a high production rate of the said structure, since graphite particles may be compressed (to a density equal to or greater than 1.6 g/cm³) after placement of the expanded graphite layer between the two metal walls, without the need for a mould.

Another purpose of the invention is a process for manufacturing a multi-layer material made of expanded graphite reinforced by a metal comprising at least one inner layer of recompressed expanded graphite and two outer metal layers, wherein a sheet of recompressed expanded graphite with a density lower than 1.2 g/cm³, typically a sheet of flexible graphite with a density between 0.8 and 1.2 g/cm³ is inserted between two metal sheets then co-rolled with them, and wherein the composite structure thus co-rolled is compressed, for example by compression or by rolling, the reduction of thicknesses being defined such that the said inner layer of recompressed expanded graphite reaches a density greater than 1.6 g/cm³ and preferably more than 1.7 g/cm³.

The metal sheets used may be made from any type of metal. They are preferably very thin, with a thickness typically less than 150 μm. The metal from which these outer layers are made is preferably aluminium (or an aluminium alloy) or copper (or a copper alloy) due to their good thermal conductivity. In this case, the thickness of the sheets may be between 50 and 100 microns, which leaves the maximum volume for the core made of recompressed expanded graphite that is the material with the highest thermal conductivity in the assembly. Steel sheets can also be used, their low thermal conductivity being partially compensated by a high mechanical strength so that thin sheets can be used, for example 20 microns. Obviously, the outer layers may be composed of a same metal or alloy, or alternatively they may be made of different metals.

The sheet of recompressed expanded graphite used may be a sheet of flexible graphite obtained according to known prior art, for example the process described in U.S. Pat. No. 3,404,061. Typically, sheets with a thickness of between 1 and 5 mm are used, with densities less than 1 2 g/cm³, typically between 0.8 g/cm³ and 1.2 g/cm³.

The sheet of flexible graphite is placed between two metal sheets. The said flexible graphite sheet is bonded to the said metal sheets by a co-rolling operation. There is no genuine plastic deformation of the sheets during co-rolling, but they are brought into contact over their common surface. The bond may be made by inserting adhesive layers between the different layers—typically based on phenolic, epoxy, polyamide, acrylic or polyurethane resin—or also preferably by using metal sheets provided with pins, the said pins being oriented towards the layer of flexible graphite.

Advantageously, the metal sheets are previously perforated such that each perforation is associated with a pin that is anchored in the sheet of flexible graphite when the assembly passes between the rolls in the rolling mill. Once the three sheets have been co-rolled, the result is a metal/flexible graphite/metal composite product with a flexible graphite core anchored in the perforated sheets. At this stage, the flexible graphite sheet has still not been strongly compressed, and its density is still within the range 0.8 g/cm³-1.2 g/cm³, values for which thermal conductivity in the plane is still limited (of the order of 100 to 140 Wm⁻¹K⁻¹).

After co-rolling, products are then compressed to densify the flexible graphite sheet. The reduction in the total thickness of the co-rolled product is defined such that the inner layer of recompressed expanded graphite reaches a density greater than 1.6 g/cm³, value starting from which a thermal conductivity similar to or greater than that of copper can be obtained. The target density will preferably be greater than 1.7 g/cm³.

The applicant has observed that the presence of pins facilitated the final compression operation. He determined that some pin geometries give sufficient anchorage of the flexible graphite sheet into the metal sheets to assure that the final product is obtained either by passing the co-rolled structure between rolls, or by compressing it between two plane plates without the need for a mould. If an attempt is made to compress a stack of two smooth metal sheets on each side of a flexible graphite sheet, the sheet of flexible graphite starts by compressing, then after its density is approximately ⅕ g/cm³, it starts to creep perpendicular to the compression direction such that it is impossible to increase the density. The thickness of the flexible graphite sheet continues to decrease but its surface area increases. Therefore, a shape mould is necessary to confine the flexible graphite and to force its densification. The anchorage on the pins, which eliminates this creep problem, results in a large saving in manufacturing processes by enabling continuous work in a line of rolls, or pressing without the need for shape moulds.

Thus, due to the presence of the pins, a continuous process such as rolling capable of leading to high recompressed expanded graphite densities, typically 1.75 g/cm³, can be used, and this is a very important economic advantage.

These pins could for example be obtained by perforating the metal sheet: each perforation is made on the same side of the same metal sheet such that the wall in the neighborhood of the perforated orifice is deformed and there is a projection from the said metal sheet with sufficient height to form the said mechanical bond. The pin may be the result of partial punching of the metal layer, the partially punched part then being folded along the unpunched part acting as a hinge. The pin can also be the result of a complete perforation of the sheet, the surface around the perforated orifice being deformed and being in the form of an approximately axisymmetric projection. This final pin shape is preferred since the recesses and hollows created by anchorage of the pins in the flexible graphite layer during co-rolling are more easily and quickly filled by creep, during the final compression.

The applicant has determined firstly that there must be a large number of perforations uniformly distributed on the metal sheets and each perforation must be sufficiently large so that the flexible graphite creeps and occupies the space left free by the perforation, and also that the size of the metal pins associated with these perforations must be sufficiently large to enable efficient anchorage of flexible graphite on the sheet, as a function of the final thickness of the fin. It has also been observed that as the target thickness of the recompressed expanded graphite core increases, the surface area of the perforation also needs to increase to limit compression creep of the flexible graphite. Thus, the surface area of these perforations must represent at least 3%, and preferably at least 5%, of the total surface area of the metal layer and the height of the pins must be equal to at least 15% of the thickness of the layer of recompressed expanded graphite. Preferably, each of these perforations has a surface area of between 0.2 mm² and 16 mm^{2.} When the total surface area of these perforations accounts for a large proportion of the total surface area of the metal layer, typically 50%, and particularly when the graphite layer is densified by rolling, the thickness of the outer metal layers should be increased to improve the mechanical behaviour of the assembly.

Another purpose of the invention is a flat product such as a plate or strip, characterized in that it is composed of a multi-layer material, comprising at least one inner layer of recompressed expanded graphite and two outer metal layers. Preferably, the recompressed expanded graphite has a density greater than 1.6 g/cm³, or even better greater than 1.7 g/cm³. The metal layers may be made of any type of metal. Typically, the global thickness of this product is between 1 and 5 mm, with the outer metal sheets preferably being very thin, typically thinner than 150 μm, for example between 50 and 100 microns for an aluminium (or aluminium alloy) sheet or a copper (or copper alloy) sheet. Steel sheets may also be suitable, since their low thermal conductivity is partially compensated by high mechanical strength so that they may be made thinner, for example 20 microns.

Preferably, outer metal layers are provided with uniformly distributed pins facing the layer of recompressed expanded graphite. The pins may be associated with perforations. For example, they may be large plates, typically 1 m*1 m, from which cooling fins may be cut out according to the required shapes. They may also be continuous narrow strips cut out to form the required length of fins.

Another purpose of the invention is an element of a heat dissipating device such as a heat sink fin, made with the structure according to the invention. It may be cut out from a plate like that described above or it may be made such that the fin assembly, including the edges, is covered by a metal layer.

The edges perpendicular to the plane of the material are often weak points, and can be masked. The preferred solution to achieve this result is to co-roll a flexible graphite strip inserted between wider metal sheets, one edge of each of the said sheets projecting beyond the opposite edges of the graphite sheet, such that metal side strips project beyond the strip of flexible graphite after the co-rolling operation. These side strips are then folded so as to cover the edges, and the compression operation is then performed. Two edges are thus covered.

The four edges can be covered according to the same principle, with the difference that co-rolling and rolling operations have to be replaced by compression under a press done separately for each fin.

The fin according to the invention has many technical and economic advantages:

its conductivity is very good in the direction of its plane. For example, the thermal conductivity of a composite made with two 100 micron thick aluminium skins and a recompressed expanded graphite core with a density of 1.85 g/cm³ is 430 Wm⁻¹K⁻¹ in the plane of the fins, which is better than could have been obtained with solid copper fins;

it is light weight. For example, the apparent density of the fin mentioned above, with a total thickness of 1.5 mm (0.2 mm of aluminium and 1.3 mm of recompressed expanded graphite) is 1.96, such that the weight is 28% less than it would have been for a solid aluminium fin (with only half the conductivity), and 4 times lighter than a solid copper fin with approximately the same conductivity;

it does not contain any component that is degraded by heat, up to the melting temperature of the metal used for the metal faces. In one of the worst cases (aluminium faces), the temperature would have to be 660° C., which is beyond the operating range of an electronic component. This lack of a temperature limit enables brazing techniques, or even soldering techniques, to fix the fins to their support;

the outer faces of the fin are metal sheets, resistant to abrasion and shock, particularly if they are compared with essentially recompressed expanded graphite based products, for example like those described in US 2004/0000391;

the high density recompressed expanded graphite core assures that the product has a capacity to be compressed without breakage, for example which enables assembly in a support by force fitting or trapping in a groove. This is another important advantage compared with the material described in US 2004/0000391, which is too brittle to tolerate this type of assembly.

the outer stiffeners anchored in the recompressed expanded graphite make the assembly sufficiently stiff for it to be used as a fin in cooling systems, without the need for resin impregnation that would set in depth and embrittle the recompressed expanded graphite.

the product can be made in large quantities by continuous processes, essentially a sequence of rolling and co-rolling operations, which means that cost prices are significantly lower than a hot press process.

the outer surfaces are made of metal and consequently are suitable for connection operations by brazing if it is required to fix the fins to metal supports. These brazing connections provide an unequalled quality of heat transfer between the metal support to be cooled and the fins that dissipate heat into the air.

Another purpose of the invention is providing a heat dissipating device, such as a heat sink, which comprises fins according to the invention.

### BRIEF DESCRIPTION OF THE DRAWINGS

FIG. 1 shows a section through a plate with a multi-layer structure according to the invention.

FIG. 2 shows two steps in the production of a fin according to the invention, the edges of which are also covered by an external metal layer.

### DESCRIPTION OF PREFERRED EMBODIMENTS

### EXAMPLE 1

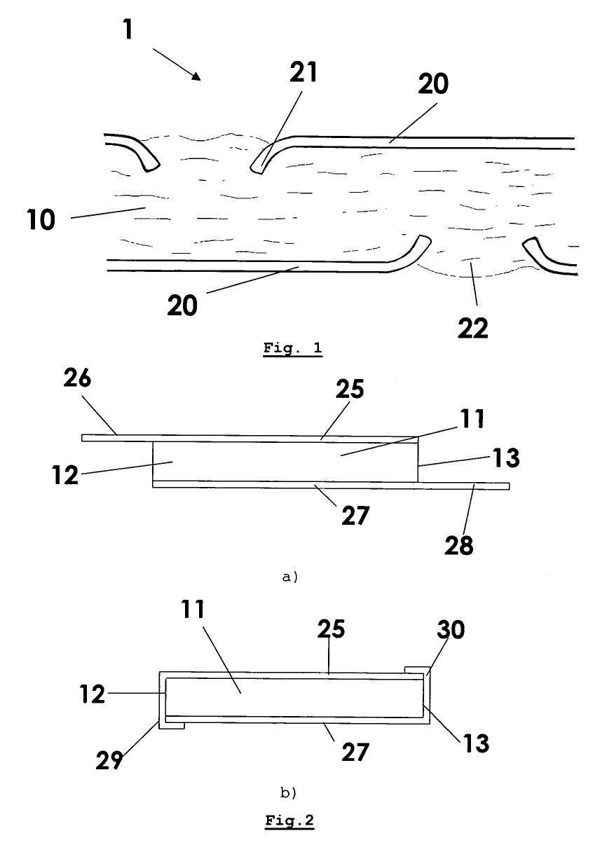

### Manufacturing of a Multi-Layer Plate According to the Invention (FIG. 1)

A flexible graphite sheet according to known prior art is produced (for example U.S. Pat. No. 3,404,061). Typically, it is required to obtain a sheet between 1 and 5 mm thick, with density close to 1.

For a co-rolling operation, the next step is to bond this flexible graphite sheet to thin previously perforated metal sheets, such that the perforation is surrounded by a pin anchored into the flexible graphite sheet during the pass through the rolling mill.

Once the three sheets have been co-rolled, the resulting metal/flexible graphite/metal composite product is obtained with a flexible graphite core anchored in the perforated sheets. At this stage, the flexible graphite sheet has still not been strongly compressed, and its density is still within the range 0.8-1.2 g/cm³, values for which the thermal conductivity in the plane is still limited (of the order of 150 to 250 Wm⁻¹K⁻¹).

After co-rolling, the product is then compressed to densify the flexible graphite sheet until its density reaches 1.7 g/cm³, since at higher values the thermal conductivity is greater than copper (greater than 380 Wm⁻¹K⁻¹).

FIG. 1 illustrates a section through the plate (1) thus obtained with a multi-layer structure with an inner layer (10) made of recompressed expanded graphite with a density of 1.85 g/cm³, clamped between two outer metal layers (20) provided with pins (21) associated with uniformly distributed perforations (22) (277 per dm²) . The thermal conductivity of the inner layer of recompressed expanded graphite is 430 Wm⁻¹K⁻¹.

The composite plate (1) is large (1 m×1 m). Fins with the required shape can be cut out from it.

### EXAMPLE 2

### Typical Materials made According to the Invention and Methods of Production

Table I lists properties of four structures according to the invention, according to their different methods of production, compared with solid metal products. The numbers in the table show that the fins according to the invention are very competitive with solid copper fins in terms of thermal performance, and are lighter in weight than fins made of solid aluminium.

TABLE 1

| | A | B | C | D | Al | Cu |
|---|---|---|---|---|---|---|
| Initial thickness | 2.5 | 2.5 | 2.5 | 5 | — | — |
| of the flexible | | | | | | |
| graphite sheet | | | | | | |
| (mm) | | | | | | |
| Initial density | 1 | 1 | 1 | 1 | — | — |
| of the flexible | | | | | | |
| graphite sheet | | | | | | |
| Nature of metal | Al | Al | Copper | Al | Al | Cu |
| sheets | | | | | | |
| Thickness of | 100 | 100 | 100 | 100 | 1500 | 1500 |
| metal sheet | | | | | | |
| (microns) | | | | | | |
| Size of | 2.25 | 2.25 | 2.25 | 4 | — | — |
| perforations | mm2 | mm2 | mm2 | mm2 | | |
| Density of | 227/ | 277/ | 277/ | 277/ | — | — |
| perforations | dm2 | dm2 | dm2 | dm2 | | |
| Fraction of the | 6.25% | 6.25% | 6.25% | 11% | — | — |
| perforated | | | | | | |
| surface area | | | | | | |
| Height of pins | 0.40 | 0.40 | 0.40 | 0.70 | — | — |
| before co- | mm | mm | mm | mm | | |
| rolling | | | | | | |
| Density of | 1.1 | 1.12 | 1.1 | 1.15 | — | — |
| flexible graph- | | | | | | |
| ite after bond- | | | | | | |
| ing co-rolling | | | | | | |
| Method of | Press | Rolling | Press | Press | — | — |
| compression | between | | between | between | | |
| after co- | planes | | planes | planes | | |
| rolling | | | | | | |
| Final density of | 1.85 | 1.75 | 1.85 | 1.90 | — | — |
| the flexible | | | | | | |
| graphite sheet | | | | | | |
| Total product | 1.55 | 1.63 | 1.55 | 2.83 | 1.5 | 1.5 |
| thickness (mm) | | | | | | |
| Apparent | 1.96 | 1.86 | 2.6 | 1.96 | 2.7 | 8 |
| product density | | | | | | |
| Thermal | 430 | 370 | 450 | 457 | 210 | 380 |
| conductivity | | | | | | |
| measured in the | | | | | | |
| plane of the | | | | | | |
| material | | | | | | |
| (W/m · K) | | | | | | |

### EXAMPLE 3

### Process for Manufacturing Fins According to the Invention, for which the Edges are Covered by outer Metal Layers (FIGS. 2a and 2b)

The edges perpendicular to the plane of the fin are often fragile points, and can be masked. This is done by co-rolling a strip (11) of flexible graphite with metal sheets (25, 27) that are wider and are offset such that their corresponding metal side strips (26, 28) each project beyond one of the opposite edges (12, 13) of the graphite strip after the co-rolling operation. These metal side strips are then folded (29, 30) over the graphite edges so as to cover them. Finally, the compression operation is performed. As illustrated on FIG. 2, left graphite edge (12) and right graphite edge (13) are thus covered.

It is possible to cover the two other graphite edges (front edge and back edge, not shown) by using the same principle, with the difference that co-rolling and rolling operations have to be replaced by compression under a press done separately for each fin.

What is claimed is:

1) Multi-layer material comprising at least one inner layer made of recompressed expanded graphite and two outer metal layers, the said recompressed expanded graphite having a density greater than 1.6 g/cm³, and preferably greater than 1.7 g/cm³, wherein each of said outer metal layers has a thickness less than one tenth of the total thickness of the multi-layer structure.

2) Material according to claim 1, wherein at least one outer metal layer is made of aluminium or aluminium alloy, its thickness being between 50 and 100 microns.

3) Material according to claim 1, wherein at least one outer metal layer is made of steel, its thickness being less than or equal to 20 microns.

4) Material according to claim 1, wherein at least one outer metal layer is made of copper or copper alloy, its thickness being between 50 and 100 microns.

5) Material according to claim 1, wherein each of said outer metal layers is adjacent to a recompressed expanded graphite layer and mechanically bonded to it.

6) Material according to claim 5, wherein the said outer metal layers are provided with uniformly distributed pins oriented towards the recompressed expanded graphite inner layer.

7) Material according to claim 6, wherein the density of the pins is greater than 25 per dm².

8) Material according to claim 6, wherein the height of the said pins is greater than 15% of the final thickness of the recompressed expanded graphite inner layer.

9) Material according to claim 6, wherein the said pins are the result of punching the outer metal layer, the wall around the perforated orifice being deformed and being in the form of an approximately axisymmetric projection.

10) Material according to claim 9, wherein the outer metal layers have at least 25 perforations per dm², the surface area of these perforations representing at least 3%, and preferably at least 5% of the total surface area of the metal layer, with pins with a height equal to at least 15% of the thickness of the layer of recompressed expanded graphite.

11) Material according to claim 10, wherein each of these perforations has a surface area between 0.2 mm² and 16 mm².

12) Method for producing a multi-layer material based on expanded graphite reinforced by a metal comprising at least one recompressed expanded graphite inner layer and two outer metal layers wherein:
a) a recompressed expanded graphite sheet with a density lower than 1.2 g/cm3, typically a sheet of flexible graphite with a density between 0.8 and 1.2 g/cm³ is inserted between two metal sheets and then co-rolled with them,
b) the composite structure thus co-rolled is then compressed, the reduction of thicknesses being defined such that the said inner layer of recompressed expanded graphite reaches a density greater than 1.6 g/cm³ and preferably more than 1.7 g/cm³.

13) Method according to claim 12, wherein the compression of the said composite co-rolled structure is carried out by rolling.

14) Method according to claim 13, wherein the said metal sheets are provided with pins oriented towards the said recompressed expanded graphite sheet that is anchored in the said sheet when the assembly passes between the rolls in the rolling mill.

15) Method according to claim 14, wherein the said pins are made by perforation of the said metal sheets, the wall around the perforated orifice being deformed and in the form of an approximately axisymmetric projection.

16) Method according to claim 15 in which more than 25 perforations per dm2 are made, the surface area of these perforations representing at least 3%, preferably 5%, of the total surface area of the outer metal layer.

17) Flat product, such as a plate or strip, composed of a multi-layer material, comprising at least one inner layer of recompressed expanded graphite and two outer metal layers, the recompressed expanded graphite having a density greater than 1.6 g/cm³, or even better greater than 1.7 g/cm³, wherein each outer metal layer has a thickness less than one tenth of the total thickness of the product.

18) Cooling fin cut out from the flat product according to claim 17.

19) Cooling fin, made of a multi-layer material, comprising at least one recompressed expanded graphite inner layer and two outer metal layers, that cover the surfaces and at least two edges of the said fin.

20) Fin according to claim 19, wherein the recompressed expanded graphite has a density greater than 1.6 g/cm³, preferably greater than 1.7 g/cm³.

21) Method for producing the fin according to claim 19, wherein:
A) said metal sheets are cut out according to dimensions wider than the dimensions of the recompressed expanded graphite sheet that they will cover;
B) optionally, said metal sheets are punched to be provided with pins;
C) said recompressed expanded graphite sheet with a density lower than 1.2 g/cm3, typically a sheet of flexible graphite with a density between 0.8 and 1.2 g/cm³, is inserted between said metal sheets, the optional pins being oriented towards the recompressed expanded graphite layer, then co-rolled with them, in such a way that a metal side strip of each of the said sheets projects beyond each of the opposite edges of the graphite sheet;
D) metal side strips are then folded over the said graphite edges so as to cover them,
E) the multilayer structure with covered edges thus obtained is finally compressed.

22) Heat sink with fins provided with cooling fins according to claim 18.
